(19) United States
(12) Patent Application Publication
(10) Pub. No.: US 2013/0038417 A1
(43) Pub. Date: Feb. 14, 2013

(54) COIL COMPONENT AND MANUFACTURING METHOD THEREOF

(71) Applicants: Yong Suk Kim, Yongin (KR); Kang Heon Hur, Seongnam (KR); Sang Moon Lee, Seoul (KR); Young Seuck Yoo, Seoul (KR); Jeong Bok Kwak, Suwon (KR); Sung Kwon Wi, Seoul (KR)

(72) Inventors: Yong Suk Kim, Yongin (KR); Kang Heon Hur, Seongnam (KR); Sang Moon Lee, Seoul (KR); Young Seuck Yoo, Seoul (KR); Jeong Bok Kwak, Suwon (KR); Sung Kwon Wi, Seoul (KR)

(73) Assignee: SAMSUNG ELECTRO-MECHANICS CO., LTD.

(21) Appl. No.: 13/275,857

(22) Filed: Oct. 18, 2011

(30) Foreign Application Priority Data
Aug. 11, 2011 (KR) 10-2011-0080144

(51) Int. Cl. H01F 5/04; H01F 41/04; H01F 5/00

(52) U.S. Cl. 336/192; 336/200; 29/602.1

(57) ABSTRACT

There are provided a coil component and a manufacturing method thereof which secure coupling force between a coil and a substrate. The coil component includes: a substrate unit including a first substrate layer, an insulating layer stacked on the first substrate, and a second substrate layer stacked on the insulating layer; and coil layers each interposed between the first substrate layer and the insulating layer and between the insulating layer and the second substrate layer.

### CROSS-REFERENCE TO RELATED APPLICATIONS

This application claims the priority of Korean Patent Application No. 10-2011-0080144 filed on Aug. 11, 2011, in the Korean Intellectual Property Office, the disclosure of which is incorporated herein by reference.

### BACKGROUND OF THE INVENTION

1. Field of the Invention

The present invention relates to a coil component and a manufacturing method thereof, which may secure a coupling force between a coil and a substrate in a thin coil component.

2. Description of the Related Art

Generally, a Switching Mode Power Supply (SMPS) is used in a display device, a printer, and other electric or electronic devices as a power supply unit.

The SMPS is a modular power supply device that may convert electricity supplied from the outside in accordance with the requirements of various electric or electronic devices such as a computer, a television (TV), a Video Cassette Recorder (VCR), an exchanger, a wireless communication device, or the like. The SMPS controls the interruption of a high frequency equal to or greater than a commercial frequency by using semiconductor switching characteristics, and substantially reduces an impact.

In this SMPS, a coil component (for example, a line filter) is generally provided to improve EMI (electromagnetic interference). The line filter is a coil component in which a coil is wound on a core, and a toroidal (or troidal) line filter is mainly used as the line filter provided in anSMPS according to the related art.

However, a line filter according to the related art (for example, a choke coil) may have a defect in that it may not meet consumer demand for lightweight and compact products, due to an increase in a volume of the SMPS caused by the large size of a line filter according to the related art.

### SUMMARY OF THE INVENTION

An aspect of the present invention provides a coil component having a significantly reduced thickness by mounting a coil component on a substrate.

Another aspect of the presenst invention provides a coil component that may secure coupling force between a coil and a substrate.

Another aspect of the present invention provides a mathod of manufacturing a coil component that may secure coupling force between a coil and a substrate.

According to an aspect of the present invention, there is provided a coil component, including: a substrate unit including a first substrate layer, an insulating layer stacked on the first substrate, and a second substrate layer stacked on the insulating layer; and coil layers, each interposed between the first substrate layer and the insulating layer and between the insulating layer and the second substrate layer.

The first substrate layer may be a ferrite sintered substrate.

The second substrate layer maybe formed of a resin mixed with a ferrite powder.

The first substrate layer or the insulating layer may have a coil groove formed in a surface thereof, and the coil layer may be formed in the coil groove.

The first substrate layer or the insulating layer and the coil layer may include a bottom layer of a metallic material formed therebetween.

The coil component may further include an insulation coating layer interposed between the first substrate layer and the bottom layer, and formed of a material having a low dielectric constant.

The coil component may further include a plurality of external connection terminals formed on an outside of the substrate layer, and electrically connected with the coil layer.

According to another aspect of the present invention, there is provided a coil component, including:a first substrate layer having a coil groove formed therein; a first bottom layer of a metallic material formed inside the coil groove; and a first coil protruded outwardly of the first substrate layer on the first bottom layer.

The first substrate layer and the first bottom layer may include an insulation coating layer formed of a material having a low dielectric constant interposed therebetween.

The coil component may further include an insulating layer formed on the first coil; a second coil formed on the insulating layer; and a second substrate layer formed on the second coil.

The insulating layer may have a coil groove formed therein, and the second coil may be protruded outwardly of the insulating layer in the coil groove of the insulating layer.

The coil groove of the insulating layer and the second coil may include a second bottom layer interposed therebetween.

The second substrate layer may be formed of a resin material mixed with a ferrite powder.

According to another aspect of the present invention, there is provided a manufacturing method of a coil component, including: forming a coil groove in an upper surface of a first substrate layer; forming a bottom layer of a metallic material on the upper surface of the first substrate layer; forming a mask outside the coil groove; forming a first coil in the coil groove; removing the mask; and removing the bottom layer formed on a portion other than the coil groove of the upper surface of the first substrate layer.

The manufacturing method may further include forming an insulation coating layer of a material having a low dielectric constant on the upper surface of the first substrate layer before the forming of the bottom layer.

The first coil may be formed using an electroplating method.

The manufacturing method may further include: after the removing of the bottom layer, forming an insulating layer on the first coil; and forming a second coil on the insulating layer.

The manufacturing method may further include forming a second substrate layer on the second coil after the forming of the second coil.

The manufacturing method may further include forming a plurality of external connection terminals electrically connected with each of the first coil and the second coil after the forming of the second substrate layer.

The second substrate layer may be formed by coating an upper surface of the second coil with a resin mixed with a ferrite powder.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective diagram schematically showing a coil component according to an embodiment of the present invention;

FIG. 2 is a cross-sectional diagram of the coil component of FIG. 1 taken from line A-A′;

FIGS. 3A through 3P are diagrams showing a manufacturing method of a coil component according to an embodiment of the present inveniton.

### DETAILED DESCRIPTION OF THE INVENTION

Terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention. Therefore, the configurations described in the embodiments and drawings of the present invention are merely appropriate embodiments but do not represent all of the technical spirit of the present invention. Thus, the present invention should be construed as including all the changes, equivalents, and substitutions included in the spirit and scope of the present invention at the time of filing this application.

Hereinafter, embodiments of the present invention will be described in detail with reference to the accompanying drawings. In this case, it should be noted that like reference numerals denote like elements in the accompanying drawings. Moreover, a detailed description of well-known functions or configurations will be omitted in order not to unnecessarily obscure the subject matter of the present invention. For the same reason, it is to be noted that some components shown in the accompanying drawings are exaggerated, omitted or schematically illustrated, and the size of each component may not exactly reflect its true size.

Hereinafter, embodiments of the present invention will be described in detail with reference to the accompanying drawings.

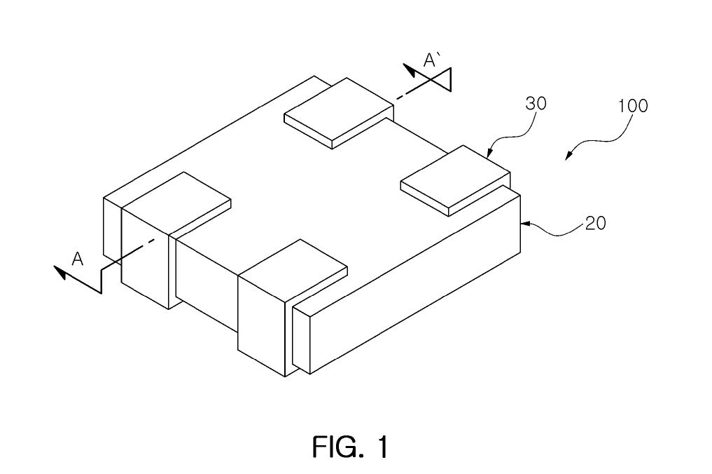

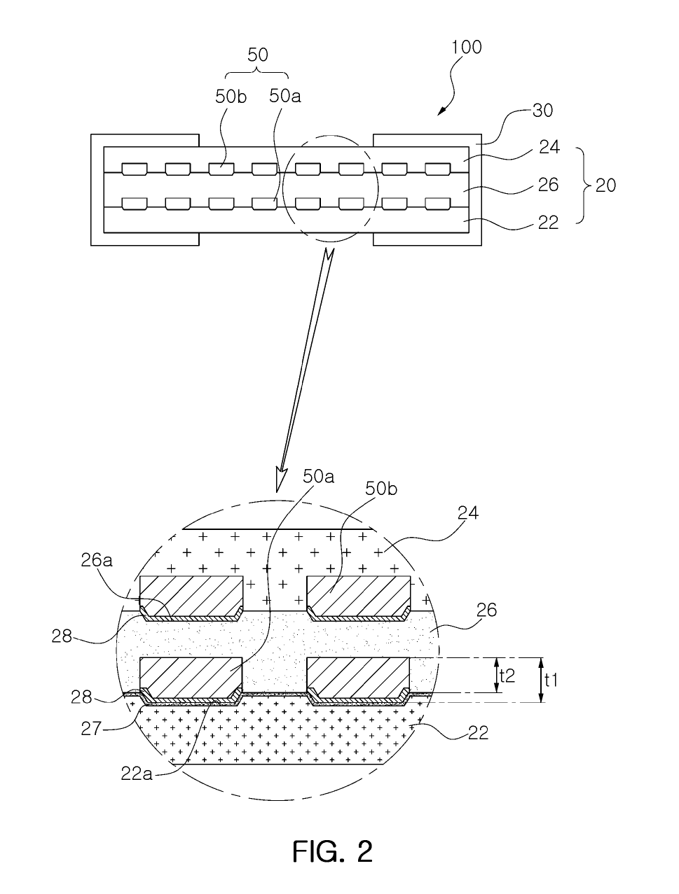

FIG. 1 is a perspective diagram schematically showing a coil component according to an embodiment of the present invention, and FIG. 2 is a cross-sectional diagram of the coil component of FIG. 1 taken from line A-A′.

Referring to FIGS. 1 and 2, a coil component 100 according to an embodiment of the present invention may be a chip-type coil component 100 formed such that a coil pattern is printed on a magnetic sheet (for example, a ferrite sheet), and may include a coil layer 50, a substrate unit 20, and an external connection terminal 30.

The coil layer 50 may include a first coil 50a and a second coil 50b. Here, when the coil component 100 according to an embodiment of the present invention is a line filter (for example, a common mode filter), any one of the first coil 50a and the second coil 50b may be used as a live line, and the remaining coil may be used as a neutral line.

As for the coil layer 50 according to an embodiment of the present invention, the first coil 50a may be disposed in a lower portion of the coil layer 50, and the second coil 50b maybe disposed above the first coil 50a. However, the present invention is not limited thereto, and the first coil 50a and the second coil 50b may be inversely disposed.

Both the first coil 50a and the second coil 50b may have a spiral shape. In addition, the spiral shape of each of the first coil 50a and the second coil 50b may have a concentric circle.

Each of the first coil 50a and the second coil 50b may be electrically connected to the external connection terminal 30, to be described later, to thereby be electrically connected to the outside through the external connection terminal 30.

The substrate unit 20 may include a first substrate layer 22, a second substrate layer 24, and an insulating layer 26.

The first substrate layer 22 maybe disposed on a surface (for example, a lower surface) of the coil component 100. Also, the first coil 50a may be disposed on an inner surface of the first substrate layer 22, that is, an upper surface thereof. In addition, a coil groove 22a maybe formed in an upper surface of the first substrate layer 22 to conform to the shape of the first coil 50a.

Also, an insulation coating layer 27 and a bottom layer 28 may be formed inside the coil groove 22a.

The insulation coating layer 27 may have the form of a thin film within the coil groove 22a of the first substrate layer 22, and be formed of an insulation material and a material having a relatively low dielectric constant.

For example, as the material of the insulation coating layer 27, a mixture of at least one of ceramic, parylene, LCP (liquid crystal polymer), PE (poly ethylene), PP (polypropylene), PA (polyamide), teflon, or the like maybe used. Also, a material mixed with ceramic and polymer may be used, as necessary.

The insulation coating layer 27 may be provided to significantly reduce parasitic capacitance generated between the coil layers 50. Accordingly, when parasitic capacitance can be substantially reduced even without the insulation coating layer 27, the insulation coating layer 27 may be omitted.

The bottom layer 28 may be formed to have the form of a thin film on the insulation coating lyaer 27 within the coil groove 22a of the first substrate layer 22.

The bottom layer 28 may be formed of a conductive material. In particular, the bottom layer 28 may be formed of a material which is may be easily coupled to a material of the coil layer 50, and has a high coupling force with the coil layer 50.

For example, the bottom layer 28 may be a metal layer consisting of at least one selected from titanium (Ti), chromium (Cr), nickel (Ni), copper (Cu), silver (Ag), or gold (Au).

Also, a metal layer formed of copper (Cu), silver (Ag), or gold (Au) may be further formed on a metal layer formed of titanium (Ti), chromium (Cr), or nickel (Ni) to thereby form the bottom layer 28.

When the first coil 50a is formed on the first substrate layer 22, the bottom layer 28 may be provided to allow the first coil 50a to be stably coupled to the first substrate layer 22. Also, the bottom layer 28 may be provided to prevent etching solution, and the like, from penetrating between the first coil 50a and the first substrate layer 22 during a process of forming the first coil 50a.

Meanwhile, the first substrate layer 22 may be formed of a material having high permeability, and high saturation flux density. For example, the first substrate layer 22 may be formed of a ferrite sintered substrate having high permeability, low loss, high saturation flux density, reliability, and low production costs, as compared to other materials. However, the present invention is not limited thereto.

The second substrate layer 24 may be disposed on the other surface (for example, an upper surface) of the coil component 100. Also, the second coil 50b may be disposed on an inner surface of the second substrate layer 24, that is, a lower surface thereof.

Similar to the first substrate layer 22, the second substrate layer 24 may be formed of a material having high permeability, and high saturation flux density.

The insulating layer 26 may be disposed between the first substrate layer 22 and the second substrate layer 24.

The insulating layer 26 may be formed of a resin or a polymer material which has an insulating property.

When the insulating layer 26 is disposed between the first substrate layer 22 and the second substrate layer 24, an upper surface of the insulating layer 26 is brought into contact with a lower surface of the second substrate layer 24, and the second coil 50b is interposed between the insulating layer 26 and the second substrate layer 24. Similarly, a lower surface of the insulating layer 26 is brought into contact with the upper surface of the first substrate layer 22, and the first coil 50a is interposed therebetween.

In addition, similar to the first substrate layer 22, a coil groove 26a may be formed in the upper surface of the insulating layer 26, and the bottom layer 28 may be formed within the coil groove 26a. Here, the bottom layer 28 maybe configured in the same manner as that of the bottom layer 28 of the first substrate layer 22, and therefore, a description thereof will be omitted.

The coil component 100 according to an embodiment of the present invention configured as above may be formed such that the first coil 50a and the second coil 50b are provided in the form of a circuit pattern within the substrate unit 20 having a plate shape. Accordingly, a thickness of the coil component 100 may be significantly reduced as compared to the coil component for winding a coil of a wire shape according to the related art.

In addition, as for the coil component 100 according to an embodiment of the present invention, the coil groove 22a and the bottom layer 28 may be provided on the first substrate layer 22 or the insulating layer 26, and the coil layer 50 may be more stably coupled on the first substrate layer 22 or the insulating layer 26 by the coil groove 22a and the bottom layer 28. This will be described in detail through a manufacturing method of the coil component 100, to be described later.

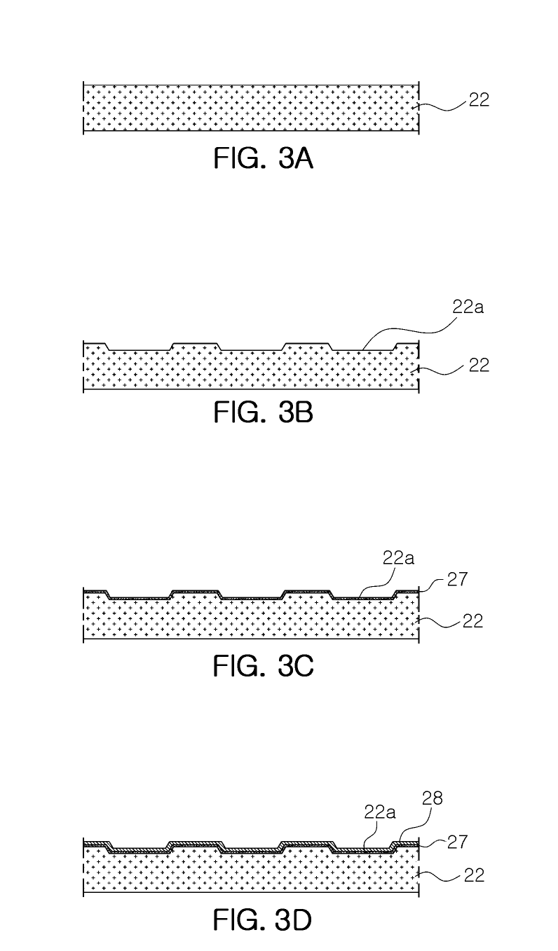

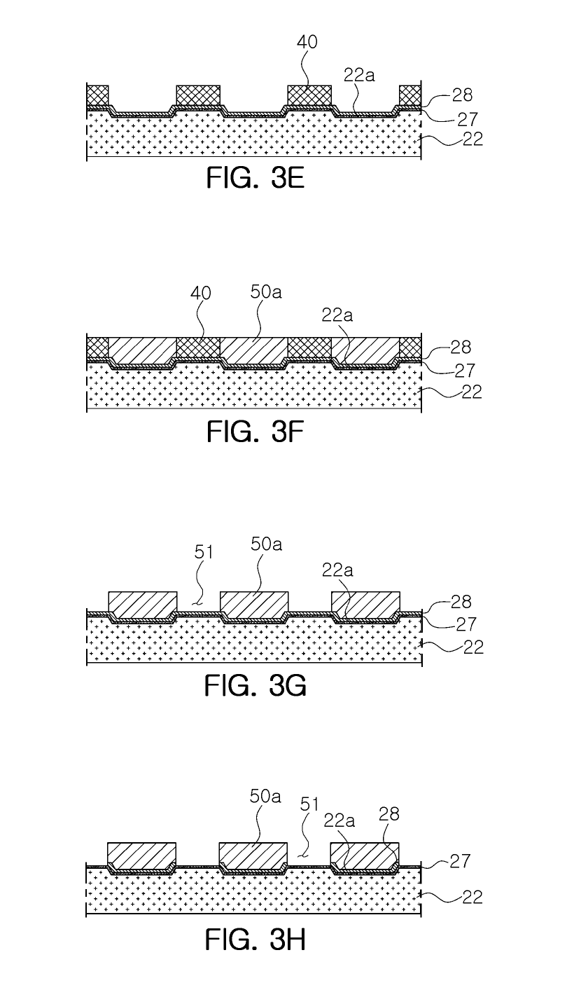

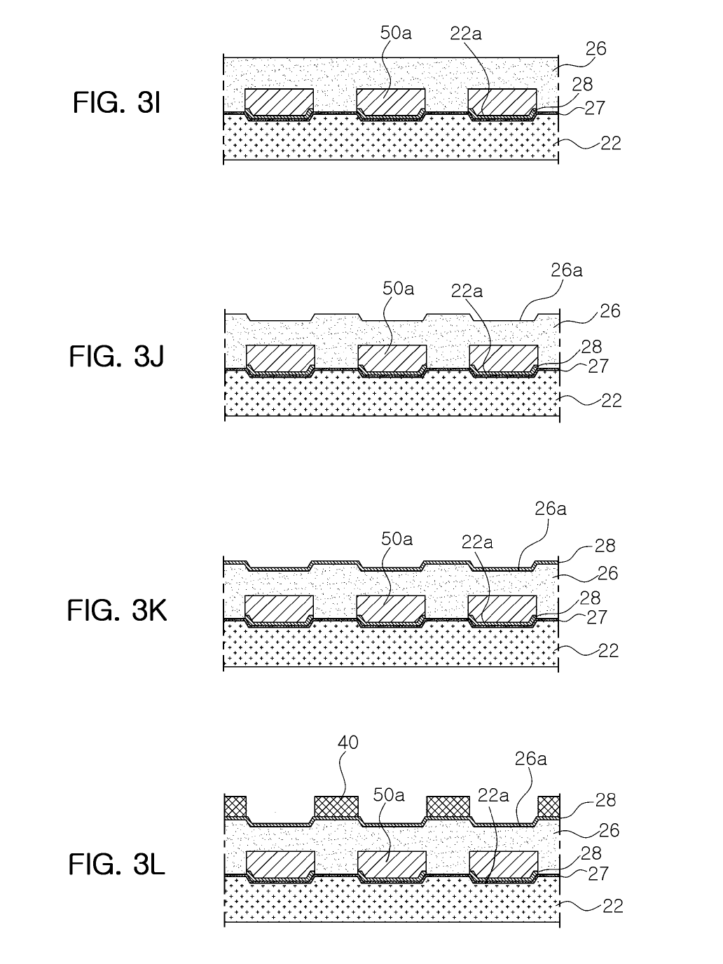

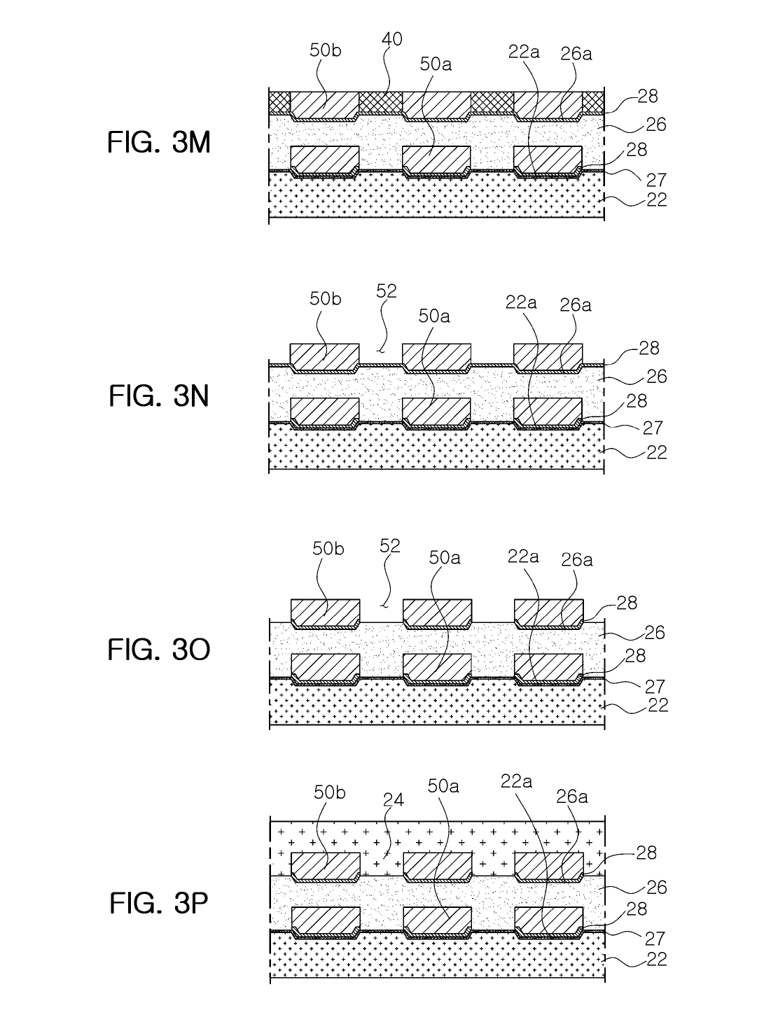

FIGS. 3A through 3P are diagrams showing a manufacturing method of a coil component according to an embodiment of the present invention.

With reference to FIGS. 3A to 3P, the manufacuturing method of the coil component according to an embodiment of the present invention will be hereinafter described.

As shown in FIG. 3A, in the manufacturing method of the coil component according to an embodiment of the present invention, the first substrate layer 22 may be first prepared.

The first substrate layer 22 according to the embodiment of the present invention may be a ferrite sintered substrate. In addition, contaminants attached to a surface of the first substrate 22 may be removed while the first substrate layer 22 is prepared.

Next, as shown in FIG. 3B, the coil groove 22a may be formed in a surface of the first substrate layer 22, that is, the upper surface thereof. In this instance, the formed coil groove 22a may be provided to form the first coil 50a of FIG. 2. Accordingly, the coil groove 22a maybe formed to correspond to a position in which the first coil 50a is formed.

Next, as shown in FIG. 3C, the insulation coating layer 27 may be formed on the upper surface of the first substrate layer 22. In this instance, the insulation coating layer 27 may be formed across the upper surface of the first substrate layer 22.

The insulation coating layer 27 maybe formed such that a material being in a slurry or paste state is coated on the upper surface of the first substrate layer 22. In addition, the insulation coating layer 27 may be provided in the form of a thin film formed using sputtering, an aerosol, an e-beam, or the like.

Meanwhile, as described above, the insulation coating layer 27 may be provided to significantly reduce parasitic capacitance generated between the coil layers 50.

Accordingly, if parasitic capacitance can be substantially reduced, even without the insulation coating layer 27, the forming of the insulation coating layer 27 may be omitted, as necessary.

Next, as shown in FIG. 3D, the bottom layer 28 may be formed on the upper surface of the insulation coating layer 27. In this instance, the bottom layer 28 may be formed across the upper surface of the insulation coating layer 27.

The bottom layer 28 may be provided in the form of a thin film on the insulation coating layer 27 by using sputtering, an aerosol, an e-beam, or the like. In addition, the bottom layer 28 may be formed using a cold spray coating method under a high pressure of argon (Ar), helium (He), or nitrogen (N₂) atmosphere.

Next, as shown in FIG. 3E, a mask 40 may be formed. The mask 40 may be formed through an etching process which is generally utilized when manufacturing a substrate. More specifically, the mask 40 may be formed such that a dry film is pressure-bonded to the upper surface of the bottom layer 28, or the upper surface of the bottom layer 28 is coated with a PR (photo-resist) to thereby be subjected to a process such as exposure, etching, or the like.

Next, as shown in FIG. 3F, the first coil 50a may be formed on the bottom layer 28.

The first coil 50a according to an embodiment of the present invention maybe formed using an electroplating method. That is, the first substrate layer 22 is impregnated with an electrolyte, and a voltage is then applied to the bottom layer 28 having conductivity, so that the first coil 50a maybe grown within spaces formed in the mask 40.

In the case of the present embodiment, the bottom layer 28 is formed across the upper surface of the first substrate layer 22. Accordingly, the electroplating method may be readily applied.

Meanwhile, the forming of the first coil 50a according to an embodiment of the present invention is not limited to the electroplating method, and various methods such as forming the coil layer 50 using a screen printing method, and the like may be used, as necessary.

Next, as shown in FIG. 3G, the mask 40 may be removed. By removing the mask 40, only the first coil 50a remains on the bottom layer 28. In addition, the bottom layer 28 is exposed in a space 51 between the coil patterns of the first coil 50a.

Next, the bottom layer 28 exposed between the coil patterns of the first coil 50a may be removed. The bottom layer 28 is removed by etching only the bottom layer 28 using the first coil 50a as the mask 40. Thus, as shown in FIG. 3H, the bottom layer 28 is removed, and only the insulation coating layer 27 remains in the space 51 between the coil patterns, so that the first coil 50a has a complete coil pattern.

Meanwhil, as for the coil component 100 according to the present embodiment, a depth, t2 of FIG. 2, of the space 51 between the coil patterns is shallower than a depth t1 of FIG. 2 of a portion (that is, the coil groove) in which the coil pattern is formed.

In this manner, with regard to the coil component 100 according to the present embodiment, the depth of the space 51 between the coil patterns maybe formed to be shallower, so that etching solution may easily flow into the space 51 between the coil patterns when removing the bottom layer 28. Accordingly, the bottom layer 28 formed in the space 51 between the coil patterns may be completely removed.

When the first coil 50a is completely formed through the above described process, the second coil 50b may be subsequently formed. In the forming of the second coil 50b, the insulating layer 26 may be first formed above the first coil 50a.

As shown in FIG. 3I, the insulating layer 26 may be formed on an upper part of the first coil 50a to completely cover the first coil 50a. As described above, the insulating layer 26 may be formed such that resin or a polymer material is coated on the first coil 50a to thereby be cured.

Next, as shown in FIG. 3J, the coil groove 26a may be formed in a surface of the insulating layer 26, that is, an upper surface thereof. In this instance, the formed coil groove 26a is provided to form the second coil 50b. Accordingly, the coil groove 26a may be formed to correspond to a position where the second coil 50b is formed.

Next, as shown in FIG. 3K, the bottom layer 28 may be formed on the insulating layer 26. In this instance, the bottom layer 28 may be formed across the upper surface of the insulating layer 26.

Here, the insulating layer 26 itself may perform functions of the above described insulation coating layer 27 of FIG. 2. Accordingly, in the present embodiment, only the bottom layer 28 may be formed on the insulating layer 26 while the insulation coating layer is omitted. However, the insulation coating layer may be formed, as necessary.

The bottom layer 28 may be provided in the form of a thin film on the insulating layer 26 by using sputtering, an aerosol, an e-beam, or the like in the same manner as that described above. In addition, the bottom layer 28 maybe formed usng a cold spray coating method under atmospheres of argon (Ar), helium (He), and nitrogen (N₂) of a high pressure in the same manner as that described above.

Next, as shown in FIG. 3L, the mask 40 may be formed. The forming of the mask 40 may be undertaken in the same manner as that in FIG. 3E, and thus a detailed description thereof will be omitted.

Next, as shown in FIG. 3M, the second coil 50b may be formed.

As described above, the second coil 50b may be formed using the electroplating method in the same manner as that of the first coil.

Next, as shown in FIG. 3N, the mask 40 may be removed. By removing the mask 40, only the second coil 50b may remain on the bottom layer 28. In addition, the bottom layer 28 is exposed in a space 52 between coil patterns of the second coil 50b.

Next, the exposure bottom layer 28 exposed between the coil patterns of the second coil 50b may be removed. Through the removing of the bottom layer 28, the bottom layer 28 formed in a portion other than the coil groove 22a of the upper surface of the first substrate layer 22 is wholly removed.

The bottom layer 28 may be removed by etching only the bottom layer 28 by using the second coil 50b as the mask 40. Therefore, as shown in FIG. 3O, the bottom layer 28 is removed in the space 52 between the coil patterns, such that the second coil 50b has a complete coil pattern.

When the second coil 50b is completely formed through the above described process, the second substrate layer 24 may be subsequently formed on an upper part of the second coil 50b. As shown in FIG. 3P, the second substrate layer 24 may be formed on the upper part of the second coil 50b to completely cover the second coil 50b.

The second substrate 24 may be formed such that resin mixed with a ferrite powder is coated on the second coil 50b to thereby be cured. Accordingly, the second substrate layer 24 is formed of a resin material; however, the resin material has high permeability and high saturation flux density through the ferrite powder, in the same manner as that of the first substrate layer 22.

Finally, a plurality of external connection terminals 30 may be formed on an outer surface of the substrate unit 20. In this instance, the plurality of external connection terminals 30 may be electrically connected to the first coil 50a and the second coil 50b, respectively.

Thus, the coil component 100 according to the present embodiment shown in FIG. 1 is completely formed.

As for the coil component according to the present embodiment configured as the above, the coil groove is formed first, the bottom layer is formed in the coil groove, and then the coil layer is formed.

Therefore, a part of the coil layer is disposed inside the coil groove, such that an amount by which the coil layer is protruded upwardly of the first substrate layer or the insulating layer may be significantly reduced, and at the same time, a contact surface between the coil layer and the substrate unit (that is, the first substrate layer and the insulating layer) may be expanded.

In addition, as the coil groove is used, the depth (t2 of FIG. 2) of the spaces (51 of FIG. 3G and 52 of FIG. 3N) between the coil patterns of the coil layer may be formed to be shallower. Accordingly, the etching solution may easily flow into the space between the coil patterns in the etching process, so that the bottom layer between the coil patterns may be completely removed.

Therefore, since an interval between the coil patterns maybe formed to be narrower, a more compact coil component may be manufactured.

The coil component according to the present embodiment may be used by forming the bottom layer between the first substrate layer and the first coil (or between the insulation layer and the second coil). As described above, the bottom layer may be formed such that the etching solution is prevented from perminating between the first substrate layer and the first coil (or between the insulation layer and the second coil), thereby improving coupling force and adhesion between the first substrate layer and the first coil (or between the insulation layer and the second coil).

Meanwhile, the coil component according to the present invention is not limited to the embodiments described above, and various applications can be provided.

For example, according to the above described embodiments, all substrate layers are formed in a stacked manner. However, the present invention is not limited thereto.

That is, a plurality of coil components having the component form shown in FIGS. 3H or 3I are manufactured, and then two of the coil components are stacked to enable the coils to be opposed to each other, thereby forming one coil component.

In this instance, the coil component of the component form shown in FIG. 3H may be stacked while the insulating layer is interposed between the two coil components. In addition, the coil component of the component form shown in FIG. 3I may be stacked by adjusting a thickness of the insulating layer.

In addition, in the embodiments described above, an example in which the coil layer includes only the first coil layer and the second coil layer is given; however, the present invention is not limited thereto.

That is, various applications can be provided such as stacking at least three coil layers, forming a plurality of coil patterns on the first substrate layer (or the insulating layer), and the like.

Here, when the coil component is formed such that at least three coil layers are stacked, the forming of the insulating layer and the second coil described above may be repeatedly performed.

In addition, the chip-type coil component in the embodiment described above may be provided; however, without being limited thereto, a component may be widely applied as long as the component includes a coil.

As set forth above, according to the embodiments of the present invention, in the manufacturing method of a coil component, coil grooves may be formed first, the bottom layer in the coil groove may then be formed, and the coil layer may be formed therein.

Therefore, a part of the coil layer is disposed inside the coil groove, so that a height by which the coil layer is protruded upwardly of the first substrate layer or the insulating layer is significantly reduced, and at the same time, a contact surface between the coil layer and a substrate unit (that is, the first substrate layer and the insulating layer) is expanded.

In addition, a depth of a space between coil pattens of the coil layer may be formed to be shallower as the coil groove is used, so that etching solution easily flows into the space between the coil patterns in an etching process, thereby completely removing the bottom layer between the coil patterns.

Therefore, since an interval between the coil patterns may be formed to be narrower, a more compact coil component can be manufactured.

In addition, according to an embodiment of the present invention, the coil component may be used by forming the bottom layer between the first substrate layer and the first coil (or between the insulation layer and the second coil). As described above, the bottom layer may be formed such that the etching solution is prevented from perminating between the first substrate layer and the first coil (or between the insulation layer and the second coil), thereby improving coupling force and adhesion between the first substrate layer and the first coil (or between the insulation layer and the second coil).

In addtiion, according to an embodiment of the present invention, the coil component may be formed such that the first coil and the second coil are provided in the form of a circuit pattern within the substrate unit of a plate shape. Accordingly, a thickness of the coil component may be significatnly reduced as compared to the coil component for winding a coil of a wire shape accoridng to the related art.

While the present invention has been shown and described in connection with the embodiments, it will be apparent to those skilled in the art that modifications and variations can be made without departing from the spirit and scope of the invention as defined by the appended claims.

What is claimed is:

1. A coil component, comprising:
a substrate unit including a first substrate layer, an insulating layer stacked on the first substrate, and a second substrate layer stacked on the insulating layer; and
coil layers each interposed between the first substrate layer and the insulating layer and between the insulating layer and the second substrate layer.

2. The coil component of claim 1, wherein the first substrate layer is a ferrite sintered substrate.

3. The coil component of claim 1, wherein the second substrate layer is formed of a resin mixed with a ferrite powder.

4. The coil component of claim 1, wherein the first substrate layer or the insulating layer has a coil groove formed in a surface thereof, and the coil layer is formed in the coil groove.

5. The coil component of claim 1, wherein the first substrate layer or the insulating layer and the coil layer include a bottom layer of a metallic material formed therebetween.

6. The coil component of claim 5, further comprising an insulation coating layer interposed between the first substrate layer and the bottom layer, and formed of a material having a low dielectric constant.

7. The coil component of claim 1, further comprising a plurality of external connection terminals formed on an outside of the substrate layer, and electrically connected with the coil layer.

8. A coil component, comprising:
a first substrate layer having a coil groove formed therein;
a first bottom layer of a metallic material formed inside the coil groove; and
a first coil protruded outwardly of the first substrate layer on the first bottom layer.

9. The coil component of claim 8, wherein the first substrate layer and the first bottom layer include an insulation coating layer formed of a material having a low dielectric constant interposed therebetween.

10. The coil component of claim 8, further comprising:
an insulating layer formed on the first coil;
a second coil formed on the insulating layer; and
a second substrate layer formed on the second coil.

11. The coil component of claim 10, wherein the insulating layer has a coil groove formed therein, and the second coil is protruded outwardly of the insulating layer in the coil groove of the insulating layer.

12. The coil component of claim 11, wherein the coil groove of the insulating layer and the second coil include a second bottom layer interposed therebetween.

13. The coil component of claim 10, wherein the second substrate layer is formed of a resin material mixed with a ferrite powder.

14. A manufacturing method of a coil component, comprising:
forming a coil groove in an upper surface of a first substrate layer;
forming a bottom layer of a metallic material on the upper surface of the first substrate layer;
forming a mask outside the coil groove;
forming a first coil in the coil groove;
removing the mask; and
removing the bottom layer formed on a portion other than the coil groove of the upper surface of the first substrate layer.

15. The manufacturing method of claim 14, further comprising forming an insulation coating layer of a material having a low dielectric constant on the upper surface of the first substrate layer before the forming of the bottom layer.

16. The manufacturing method of claim 14, wherein the first coil is formed using an electroplating method.

17. The manufacturing method of claim 14, further comprising:
forming an insulating layer on the first coil; and
forming a second coil on the insulating layer, after the removing of the bottom layer.

18. The manufacturing method of claim 17, further comprising forming a second substrate layer on the second coil after the forming of the second coil.

19. The manufacturing method of claim 18, further comprising after the forming of the second substrate layer, forming a plurality of external connection terminals electrically connected with each of the first coil and the second coil.

20. The manufacturing method of claim 18, wherein the second substrate layer is formed by coating an upper surface of the second coil with a resin mixed with a ferrite powder.
